(19) United States
(12) Patent Application Publication
(10) Pub. No.: US 2008/0300512 A1
(43) Pub. Date: Dec. 4, 2008

(54) Habilitation Treatment Suspension Device

(76) Inventor: Sang-Joon Choi, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/158,822

(22) PCT Filed: Dec. 21, 2006
(86) PCT No.: PCT/KR2006/005630

§ 371 Date: Jun. 23, 2008

(30) Foreign Application Priority Data
Dec. 23, 2005 (KR) 10/2005-0128446

(51) Int. Cl. A61H 1/00

(52) U.S. Cl. 601/23

(57) ABSTRACT

The present invention relates to a suspension device for rehabilitation therapy, which is used in bodily function recovery, exercise and rehabilitation therapy, and more particular to one of various exercise assisting devices which is used in rehabilitation therapy for muscular strengthening, mobility of joint, flexibility of joint, cardiopulmonary function strengthening, stabilization, balance, and coordination of the human body for the bodily function recovery of those who have been injured or involved in accidents. The suspension device for rehabilitation therapy of the present invention is constructed such that the rope hanger of the present invention firmly engaged with the upper rope at the top portion thereof is engaged with the lower ropes at the lower portion thereof, wherein the lower ropes has a grip formed on the lower end thereof so as to allow a part of a user's body to be hung or leaned, so that various types of movement can be operated while a degree of the therapeutic difficulty is adjusted in limited gravity situation to thereby recover the motor nerve and coordination of the human body and the like which have been lost, and so that the swingable movement can be continued to thereby recover the muscular strengthening and the like.

### TECHNICAL FIELD

The present invention relates to a suspension device for rehabilitation therapy, which is widely usable in rehabilitation therapy and exercise.

### BACKGROUND ART

Referring to technologies relating to the rehabilitation therapy, the Korea Patent application No. 20-2001-0000940 has suggested an apparatus for restoring a sense of equilibrium via rehabilitation training so as to be available for those who have abnormalities in their senses of equilibrium due to disease or accidents. The apparatus comprises an elastic member such as a spring or an absorber attached to the lower portion of the health bike or a typical bicycle, and a sensor mounted at a bottom of the elastic member for measuring the center of gravity of the human body, thereby allowing a user who have abnormalities in a sense of equilibrium to train so as to keep her or his balance while the user is riding a bicycle. Further, the Korea Patent application No. 20-2003-0036919 has suggested an apparatus for rehabilitation and posture correction in a running machine. The apparatus is constructed such that a user can restore her or his posture while checking her or his foot shape, angle of footstep, stride and the like displayed on a monitor, and the handicapped or persons encountering rehabilitation therapy both of who feel difficulty in manual operation can readily operate the running machine by oneself by permitting all the operation with a remote controller.

There are no conventional prior arts disclosing relating to the similar or identical technologies to that of the suspension device for rehabilitation therapy according to the present invention configured in a form which uses a rope. Therefore, suspension devices for rehabilitation therapy in prior arts are merely directed to fixing devices, in which a rope hanger of the suspension device is completely fixed to the ceiling, and a rope is suspended from the rope hanger, so that a user can hold onto the rope for moving her or his body. However, such devices have a problem in that exercise efficiency may not be maximized. That is, although a suspension device must be constructed such that it has difficulty in maintaining its equilibrium, so that a user can train her or his motor nerve, which leads to maximize the exercise efficiency, the rope hanger according to the conventional suspension devices, which is a fixed point of a rope, is fixed to a plurality of fixing portions on the ceiling, so that the rope hanger cannot be moved to thereby fail to maximize the exercise efficiency. Further, since the plurality of fixing portions according to the conventional suspension devices are outwardly protruded, there still exist safety problems such as an occasion where the rope hanger may be used as an implement for hurting oneself, and the like. In addition, many problems arise in its use due to its complicated construction.

Therefore, there is a need for the rehabilitation device using a rope, which has no problem in its safety while it is used in a simple manner, as well as has a more effective help for the rehabilitation.

### DISCLOSURE OF INVENTION

### Technical Problem

Accordingly, the present invention has been made to solve the above-mentioned problems occurring in the prior art, and it is an object of the present invention to provide a suspension device for rehabilitation therapy, which can be safely used by a user although it has a single fixed point on the ceiling so as to maximize its therapy efficiency. The suspension device for rehabilitation therapy according to the present invention has several advantageous effects in that, since the suspension device has a single upper axis downwardly extended from a single ring portion which is fixed to the ceiling so as to function as a fixed point, a balanced axial motion can be obtained below the single upper axis although a plurality of lower axes are suspended from the single upper axis dissimilarly to the conventional suspension device, in which the plurality of lower axes, which are suspended below two upper axes downwardly extended from two fixed points on the ceiling, are combined with one another thereby to generate their resistance as well as cause the disequilibrium among them in case where diverse regions of the human body are simultaneously trained by using the suspension device, in that when more unbalanced axes arrangement between the upper axis and the lower axes are created, the exercise effect of the present invention can be maximized, and in that the plurality of lower axes are cooperatively moved by a user below the single upper axis, the coordination of the human body can be increasingly promoted. It is further objects to provide a suspension device for rehabilitation therapy, which permits a user to exercise her or his body in a comfortable and safe manner under different circumstances in spite of the fixing between the single ring portion and the single upper axis, although unbalanced axes arrangement between the upper axis and the lower axes may be created so as to increase an exercise effect, which can simplify its manufacturing process to thereby be widely distributed, and which can facilitate its use when applying to the excise or therapy, as well as obtain a safety in its use because it is used by peoples.

### Technical Solution

In order to accomplish the above objects, according to the present invention, there is provided a suspension device for rehabilitation therapy, which comprises lower ropes 3, a rope hanger 1 to which the lower ropes 3 is connected, and a fixing means 100 buried and mounted in the ceiling for permitting the rope hanger 1 to be suspended from the ceiling, wherein the rope hanger 1 is coupled to the center of the fixing means 100 to thereby permit the rope hanger 1 to be freely swung according to the force which is applied to the rope hanger 1 and the ropes 3, and wherein each of the lower ropes 3 has a loop-shaped grip 5 mounted at a lower free end thereof for permitting a user to insert her or his foot, leg, waist and the like thereto according to the user's rehabilitation needs, so that the user can do exercise for the rehabilitation purposes by using the loop-shaped grip 5, to thereby maximize the excise effect and obtain its safe configuration.

### ADVANTAGEOUS EFFECTS

As described above, the suspension device for rehabilitation therapy according to the present invention has several advantageous effects in that the rope hanger from which the lower ropes used by a user are downwardly extended is securely fixed to the ceiling through a single axis, that is, the upper rope, so that the swingable movement of the lower ropes about the single axis may be enhanced to thereby increase the exercise effect, in that it is readily removably provided if necessary, to thereby increase its safety by preventing people from being hurt themselves through the device, in that economical burden is reduced due to its simple construction to thereby be a great help for those who needs the rehabilitation or exercise, and in that it is easily manufactured with low cost due to its simple construction, to thereby expand its use to the hospital, health club, nursing facilities for rehabilitation, athletic facility of company, house, and the like.

### BRIEF DESCRIPTION OF THE DRAWINGS

Further objects and advantages of the invention can be more fully understood from the following detailed description taken in conjunction with the accompanying drawings, in which:

FIG. 1 is a configuration view showing a using state of the suspension device for rehabilitation therapy according to a preferred embodiment of the present invention;

FIG. 2 is a reference view showing shapes of diverse rope hanger according to the preferred embodiment of the present invention;

FIG. 3 is a reference view showing the usage method of the suspension device for rehabilitation therapy according to the preferred embodiment the present invention;

FIG. 4 is an exploded perspective view showing a configuration of the suspension device for rehabilitation therapy according to the preferred embodiment of the present invention;

FIG. 5 is a front view showing a configuration of the suspension device for rehabilitation therapy according to the preferred embodiment of the present invention;

FIG. 6 is a cross-sectional view showing the engagement between a ring portion and a fixing means according to the preferred embodiment of the present invention; and

FIG. 7 is a configuration view showing the suspension device for rehabilitation therapy according to another preferred embodiment of the present invention.

### MODE FOR THE INVENTION

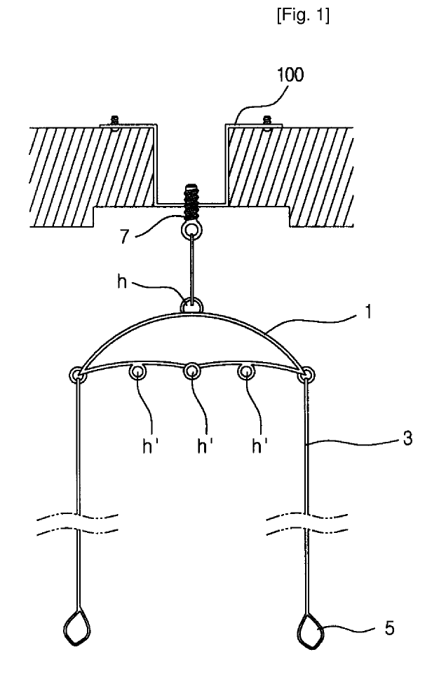

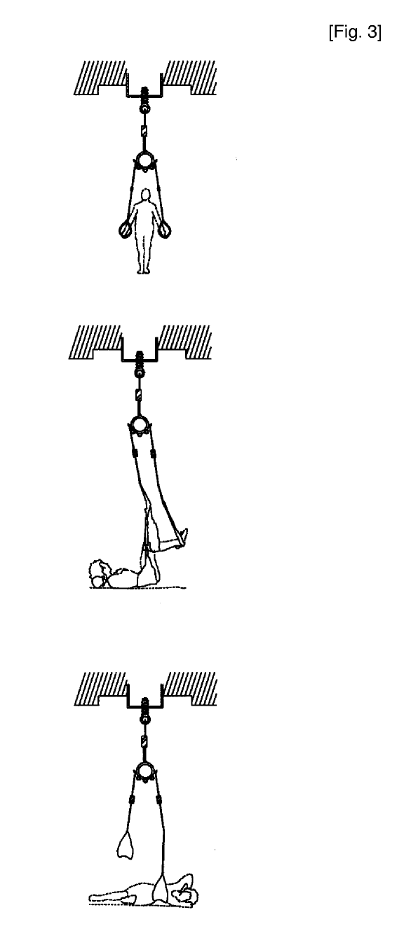

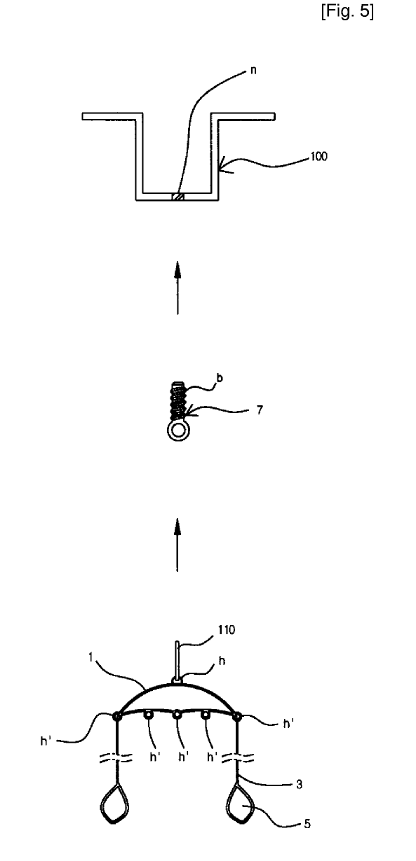

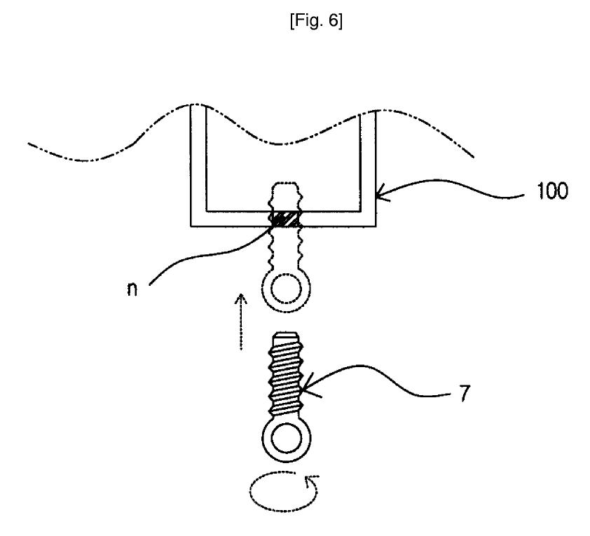

With reference to FIGS. 1 through 7, a configuration and operation of the suspension device for rehabilitation therapy of the present invention will now be described hereinafter.

A typical “therapy” has been administered only focusing on healing of damaged tissue and pain relief, and hence a functional recovery through the therapy administration has depended on each individual patient's status. And also, conventional rehabilitation therapies for a bodily functional recovery have been administered focusing on muscular strengthening, mobility of joint, flexibility of joint, and cardiopulmonary function strengthening. However, a return to work (industrial field) or sporting activities require stabilization, balance, coordination of the human body, the recent research for which has been actively advanced. The therapy program which use a rope (sling, suspension device) fixed on the ceiling has been diversely developed from 1990 in Norway in Northern Europe, as a principal country since it has been initially started in 1940 in Great Britain and Germany for rehabilitation for polio patients who had been spread over these countries. The therapies using a suspension device can permit a user to freely train all sorts of exercises such as stabilization exercise, muscular strengthening exercise and the like, as well as stretching and relaxation, all of which are required for a complete rehabilitation and a bodily function recovery, as the user can freely train the above exercises under the water in limited gravity situation. As a result, a user may train exercises with relatively less strength through the therapies using a suspension device, and also a degree of the therapeutic difficulty may be easily adjusted in a diverse manner, so that its utilization is increasingly expected. And therefore, the suspension device for rehabilitation therapy of the present invention, which has a larger exercise effect and higher safety than those of the conventional suspension device and is manufactured with relatively low cost, is devised, so that it is applied to the rehabilitation for the physically handicapped such as a postapopletic hemiplegic patient or athletes or the prophylaxis and therapy of the musculo skeletal disease which is apt to be generated in the industrial field, or the therapy for patients with chronic pain. In this manner, the most great feature of the present invention is that a ring portion which is fixed to the ceiling is not two but a single. The suspension device for rehabilitation therapy in accordance with the present invention, which comprises a single upper axis, can permit a user to more freely exercise without resistance, and maximize the stabilization of joint or the effect of sensorimotor training, to thereby increasingly enhance the exercise effect. Further, movement of one side thereof is directly transmitted to the other thereof, so that the coordination and balance ability of the human body can be significantly improved. In addition, the present invention can be easily used by applying a sling mounted on a rope for adjusting the height and breaking of the rope, which is a typical disclosed technology.

Referring to the configuration and operation of the suspension device for rehabilitation therapy of the present invention, a main configuration of the present invention will now be described as follows;

1) a ring portion detachably mounted to a fixing means securely fixed to the ceiling;

2) a length adjuster for adjusting the fixation and length of lower and upper ropes, and a rope;

3) various types of rope hangers; and

4) various types of grips which are easily used.

In other words, the suspension device for rehabilitation therapy of the present invention is provided for the purpose of the rehabilitation therapy for muscular strength, a sense of body balance and the like in the health club, hospital, rehabilitation facilities and the like so as to ensure the safety of users in use since there are many group of patients including various medical history in the hospital and rehabilitation facilities. Therefore, as shown in FIG. 1, the suspension device of the present invention is constructed such that it comprises a fixing means 100, which permits the suspension device to be fixed thereto and supported therethrough, buried in the ceiling so as not to be exposed to the outside, so that it can be prevented from being used as an implement for the purpose of unanticipated suicide and the like.

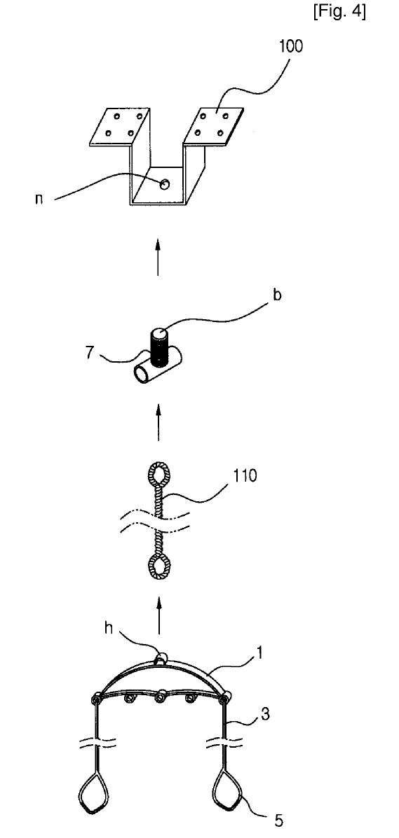

As a result, as shown in FIGS. 4 through 6, the fixing means 100 includes a support plate 101 composed of an angular U-shaped protrusion portion having a nut hole (n) formed at the center thereof and both horizontal portions outwardly extended from top portions of both sides of the angular U-shaped protrusion portion for permitting the support plate 101 to be securely fixed to the ceiling by means of a fastening means such as a bolt and the like, and a ring portion 7 having a bolt portion (b) so as to be screw-engaged with the nut hole (n) formed on one side thereof, so that the ring portion 7 can be screw-engaged with the nut hole (n) of the fixing means 100 in such a manner as to be selectively detachably engaged therewith, if necessary. And thus, in case where the present invention is not used, it can be readily removed from the ceiling, to thereby previously prevent accidents such as suicide and the like.

Meanwhile, the ring portion 7 is connected to a top portion of the rope hanger 1 through the upper rope 110.

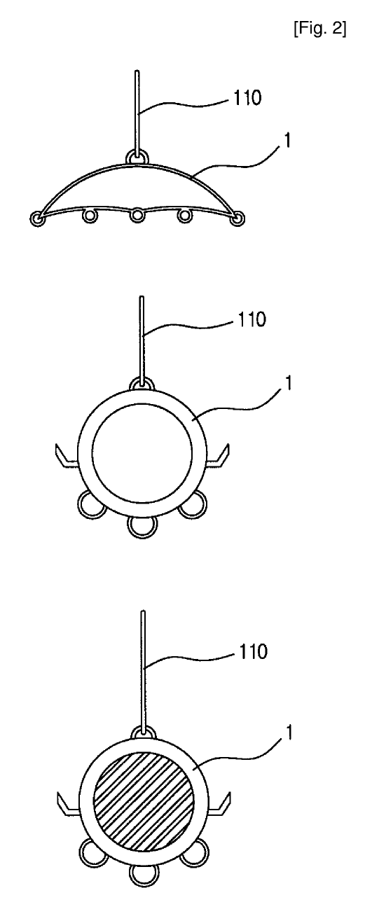

The rope hanger 1 is preferably formed in an umbrella-shape or a circular-shape, although it may be formed in any one of an umbrella-shape, a circular-shape or a rectangular-shape, as shown in FIG. 2. The rope hanger 1 includes a single upper engaging hole (h) formed on the top portion thereof so as to allow the lower free end of the upper rope 110 to be inserted thereto and engaged therewith, to thereby be connected to the ring portion 7, to which the upper free end of the upper rope 110 is engaged, so that the rope hanger 1 can be sensitively moved responding to the movement of a plurality of lower ropes 3 mounted to the lower portion of the rope hanger 1, and a plurality of lower engaging holes (h′) formed on the lower portion thereof, respectively, so as to allow the lower ropes 3 to be selectively inserted thereto and engaged therewith, to thereby be fixed thereto. In other words, the rope hanger 1 includes the single upper engaging hole (h) formed on the top portion thereof so as to be engaged to the upper rope 110 downwardly extended from the fixed means 100 mounted on the ceiling, and the plurality of lower engaging holes (h′) formed on the lower portion thereof so as to be selectively engaged and fixed to the plurality of lower ropes 3.

The lower engaging holes (h′) are selectively engaged with the lower ropes 3. Here, the engagement method can be performed such that a typical hanger means is coupled and fixed to a free end of a lower rope so as to allow the rope to be hung by the lower engaging holes (h′), or a lower rope is directly tied to the lower engaging holes (h′), and the like. Further, the lower ropes 3 includes a loop-shaped grip 5 mounted at a lower free end thereof for allowing any part of a user's body to be hung. The grip 5 can be configured by forming a loop-shaped strap or other separate member, to thereby be engaged with the lower ropes 3.

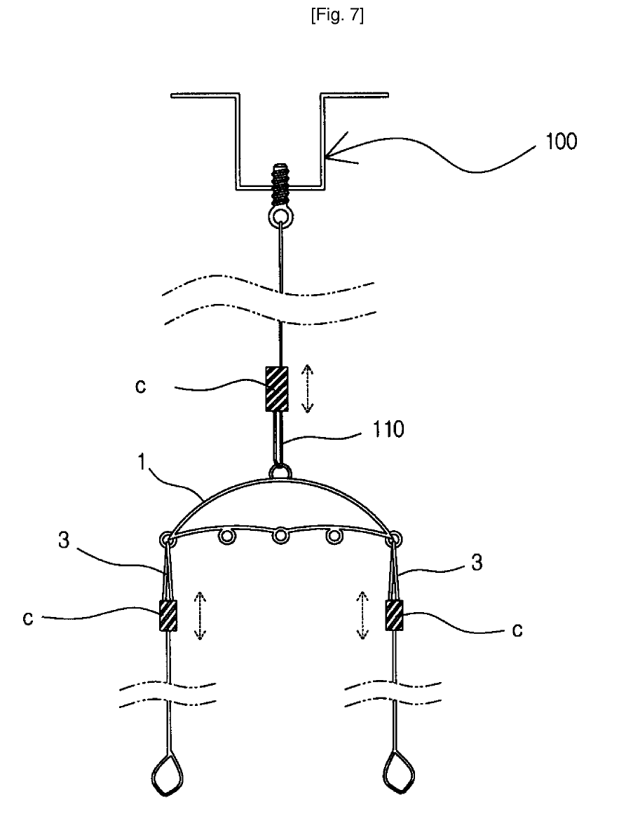

As described above, according to the present invention, each of the upper and lower ropes 110 and 3 has a separate length adjuster (c) mounted thereon, as shown in FIG. 7, for adjusting the length of the upper rope 110 and lower ropes 3, respectively. Since there are disclosed various technologies relating to the length adjustment methods and devices, as described above, the description of the length adjuster of the present invention will be omitted, but it may be applied to the present invention and used, as needed.

Hereinafter, the operation of the present invention having the configuration described above will be described with reference to FIGS. 1 through 7.

When the movement of the lower ropes 3 is transmitted to the rope hanger 1 according to a central movement caused upon applying force in a state where a part of a user's body which needs to apply force is hung by the grip 5, the rope hanger 1 is increasingly sensitively moved because it is connected to the fixing means 100 buried and mounted in the ceiling functioning as a single fixed point, so that a user using the grip 5 can keep moving his or her body so as to keep balance depending on the movement of the rope hanger 1 while applying force. As a result, the rehabilitation therapy for the motor nerves such as the muscular strengthening, the sense of body balance and the like which have been lost is administered by such continuous movement.

The rope hanger 1 may be manufactured into various shapes such as an umbrella-shape or a circular-shape or the like, but it has been devised without any angular section thereof by considering its safety since a plurality of ropes has to be readily attached or detached to/from the rope hanger 1, if necessary, and the rope hanger 1 is swung together with the ropes. The conventional and similar suspension devices have a main body for fixation and adjustment of the rope mounted on the top portion thereof, the present invention has, however, the rope hanger as well as the length adjuster for fixation and adjustment of the rope, both of which are moved below a single axis, to thereby maximize the exercise effect.

The rope hanger includes a single upper engaging hole formed on the top portion thereof so as to be connected to the ring portion through the upper rope, so that it can be sensitively moved in response to the movement of the plurality of lower ropes, and the plurality of lower engaging holes formed on the lower portion thereof so as to allow the lower ropes to be engaged therewith in diverse manners, if necessary. In other words, the outer appearance of the rope hanger may be changed in various ways, but the rope hanger must include the single upper engaging hole, with which the upper rope downwardly extended from the ring portion of the fixing means is engaged, and the plurality of lower engaging holes, with which the plurality of lower ropes are engaged.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A suspension device for rehabilitation therapy comprising:
a fixing means (100) including a support plate (101) composed of a protrusion portion having a nut hole (n) formed at the center thereof and both horizontal portions outwardly extended from top portions of both sides of the protrusion portion for permitting the support plate to be securely fixed on the ceiling by means of a fastening means such as a bolt and the like;
a ring portion (7) having a bolt portion (b) formed at one side thereof so as to be screw-engaged with the nut hole (n) formed on the fixing means (100) in such a manner as to be selectively detachably engaged therewith;
a single upper rope (110) for connecting the ring portion (7) and a rope hanger (1) to each other;
the rope hanger (1) including a single upper engaging hole (h) formed on the top portion thereof so as to allow the upper rope (110) to be engaged therewith, the upper rope (11) being downwardly extended from the ring portion (7), and a plurality of lower engaging holes (h′) formed on the lower portion thereof, respectively; and
a plurality of lower ropes (3) engaged with the plurality of lower engaging holes (h′), respectively, and including a loop-shaped grip (5) mounted at a lower end thereof for allowing a part of a user's body to be hung.

2. The suspension device for rehabilitation therapy device according to claim 1, wherein an length adjuster mounted on the rope for separately adjusting the lengths of the upper and the lower ropes (100,3).

3. The suspension device for rehabilitation therapy device according to claim 1, wherein the rope hanger (1) is formed in any one of an umbrella-shape, a circular shape or a polygonal-shape.
